(19) United States
(12) Patent Application Publication
(10) Pub. No.: US 2022/0200679 A1
(43) Pub. Date: Jun. 23, 2022

(54) Parallel Beamforming Training with Coordinated Base Stations

(71) Applicant: Google LLC, Mountain View, CA (US)

(72) Inventors: Jibing Wang, San Jose, CA (US); Erik Richard Stauffer, Sunnyvale, CA (US)

(73) Assignee: Google LLC, Mountain View, CA (US)

(21) Appl. No.: 17/610,621

(22) PCT Filed: Mar. 24, 2020
(86) PCT No.: PCT/US2020/024454

§ 371 Date: Nov. 11, 2021

Related U.S. Application Data
(60) Provisional application No. 62/847,030, filed on May 13, 2019.

(51) Int. Cl. H04B 7/06; H04L 5/00; H04L 1/00; H04B 7/024

(52) U.S. Cl. CPC H04B 7/0617; H04L 5/0048; H04B 7/024; H04L 1/0071; H04L 5/0055

(57) ABSTRACT

This document describes techniques and apparatuses for parallel beamforming training with coordinated base stations. In particular, a user equipment (UE) uses time-division multiplexing (TDM) to perform parallel beamforming training with multiple base stations within a coordination set. The TDM interleaves beamforming training signals associated with different base stations. In other words, at least one beamforming training signal associated with a first base station occurs between two beamforming training signals associated with a second base station. Example types of beamforming training signals include downlink pilot signals, uplink feedback signals, uplink pilot signals, and downlink feedback signals. In some situations, the different types of beamforming training signals are further interleaved together based on expected rates at which channel conditions change. By interleaving beamforming training signals, narrow beams can be formed to support millimeter-wave (mmW) communications at cell edges.

### BACKGROUND

Cellular and other wireless networks can increase transmission rates and throughput for newer generations of wireless communications, such as Fifth-Generation New Radio (5GNR), by using signals with higher frequencies and shorter wavelengths relative to those used for wireless communications in earlier generations. These signals can have frequencies at or near the extremely-high frequency (EHF) spectrum (e.g., frequencies greater than 24 gigahertz (GHz)) with wavelengths at or near one to ten millimeters (mmW).

There are, however, various technological challenges related to using mmW signals, such as the higher path loss experienced by mmW signals compared to earlier-generation signals. The higher path loss can make it difficult for a base station to receive a mmW signal transmitted by a device at far distances. As such, an opportunity exists to increase an effective communication range of mmW transmissions.

### SUMMARY

Techniques and apparatuses are described for parallel beamforming training with coordinated base stations. In particular, a user equipment (UE) uses time-division multiplexing (TDM) to perform parallel beamforming training with multiple base stations within a set of coordinated base stations called a “coordination set.” The TDM interleaves beamforming training signals associated with different base stations within the coordination set. In other words, at least one beamforming training signal associated with a first base station of the coordination set occurs between two beamforming training signals associated with a second base station of the coordination set. In one implementation, the first base station transmits two beamforming training signals consecutively—without other, intervening beamforming training signals. In another implementation, the first base station and the second base station alternate between transmitting different beamforming training signals. Example types of beamforming training signals include downlink pilot signals, uplink feedback signals, uplink pilot signals, and downlink feedback signals. In some situations, the different types of beamforming training signals are further interleaved together based on expected rates at which channel conditions change. By interleaving beamforming training signals using TDM, narrow beams can be formed to support millimeter-wave (mmW) communications at cell edges.

Aspects described below include a method performed by a UE. The method includes receiving first downlink pilot signals from a first base station within a coordination set and generating first uplink feedback signals based on the first downlink pilot signals. The method also includes receiving second downlink pilot signals from a second base station within the coordination set and generating second uplink feedback signals based on the second downlink pilot signals. The method additionally includes transmitting the first uplink feedback signals to the first base station and the second uplink feedback signals to the second base station in a first pattern that interleaves first transmission times of the first uplink feedback signals with second transmission times of the second uplink feedback signals. The method further includes performing parallel beamforming training with the first base station and the second base station according to the first pattern.

Aspects described below include a method performed by a UE. The method includes determining first beamforming configuration and second beamforming configurations based on one or more signals received from one or more base stations within a coordination set. The one or more base stations include a first base station and a second base station. The method also includes transmitting first uplink pilot signals to the first base station using the first beamforming configurations and second uplink pilot signals to the second base station using the second beamforming configurations. The transmitting of the first uplink pilot signals and the second uplink pilot signals are based on a first pattern that interleaves first transmission times of the first uplink pilot signals with second transmission times of the second uplink pilot signals. The method additionally includes performing parallel beamforming training with the first base station and the second base station according to the first pattern.

Aspects described below include a UE with a radio-frequency transceiver. The UE also includes a processor and memory system configured to perform any of the methods described.

Aspects described below also include a system with means for performing parallel beamforming training with coordinated base stations by interleaving one or more types of beamforming training signals across different base stations within a coordination set.

### BRIEF DESCRIPTION OF THE DRAWINGS

Apparatuses of and techniques for parallel beamforming training with coordinated base stations are described with reference to the following drawings. The same numbers are used throughout the drawings to reference like features and components:

FIG. 1 illustrates an example wireless network environment in which parallel beamforming training with coordinated base stations can be implemented.

FIG. 2 illustrates an example device diagram of a user equipment and a base station for parallel beamforming training with coordinated base stations.

FIG. 3 illustrates example communication signals for parallel beamforming training with coordinated base stations.

FIG. 4 illustrates example interleaving patterns of pilot signals and feedback signals for parallel beamforming training with coordinated base stations.

FIG. 5 illustrates other example interleaving patterns of pilot signals and feedback signals for parallel beamforming training with coordinated base stations.

FIG. 6 illustrates additional example interleaving patterns of pilot signals and feedback signals for parallel beamforming training with coordinated base stations.

FIG. 7 illustrates details of example signaling for parallel beamforming training with coordinated base stations.

FIG. 8 illustrates an example method of a user equipment for parallel beamforming training with coordinated base stations.

FIG. 9 illustrates another example method of a user equipment for parallel beamforming training with coordinated base stations.

FIG. 10 illustrates an example method of a set of coordinated base stations for parallel beamforming training with a user equipment.

FIG. 11 illustrates another example method of a set of coordinated base stations for parallel beamforming training with a user equipment.

### DETAILED DESCRIPTION

Overview

To compensate for at least a portion of the path loss experienced by a mmW signal, a user equipment (UE) can use beamforming to form a narrow beam that concentrates energy in a direction of a base station based on a beamwidth and angle of a main lobe. The narrow beam can increase signal strength for transmission or increase sensitivity for reception. To satisfy size and power constraints, the UE can use analog beamforming or hybrid beamforming to form the narrow beam using fewer transceiver chains relative to a quantity of transceiver chains needed for digital beamforming although, of course, the UE can use any beamforming methodology available. While the narrow beam improves an effective communication range of the UE, communications with other devices or base stations may not be possible unless both transmit and receive beams are pointing towards each other and have large gains. As such, the UE may have difficulty simultaneously forming other beams to support parallel communications with other devices or base stations.

Without parallel communications, it can take a significant amount of time for the UE to execute sequential beamforming training procedures with multiple base stations. During this elapsed time, changes within a communication channel between the UE and one of the base stations can make results of the beamforming training procedure with that base station obsolete before the sequence of beamforming training procedures completes.

To address this challenge, techniques are described that implement parallel beamforming training using coordinated base stations. In particular, a UE uses time-division multiplexing (TDM) to perform parallel beamforming training with multiple base stations within a set of coordinated base stations called a “coordination set.” The TDM interleaves beamforming training signals associated with different base stations within the coordination set. In other words, at least one beamforming training signal associated with a first base station of the coordination set occurs between two beamforming training signals associated with a second base station of the coordination set. In one implementation, the first base station transmits two beamforming training signals consecutively-without other, intervening beamforming training signals. In another implementation, the first base station and the second base station alternate between transmitting different beamforming training signals. Example types of beamforming training signals include downlink pilot signals, uplink feedback signals, uplink pilot signals, and downlink feedback signals. In some situations, the different types of beamforming training signals are further interleaved together based on expected rates at which channel conditions change. By interleaving beamforming training signals using TDM, narrow beams can be formed to support mmW communications at cell edges.

The term “parallel beamforming training” as used herein generally refers to a process of concurrently optimizing beamforming configurations for communications between a UE and a plurality of base stations. The beamforming training is “parallel” in the sense that it is performed concurrently (rather than at separate times) for each of a plurality of wireless communication links between a UE and a respective plurality of base stations. Parallel beamforming training using interleaved pilot signals and/or interleaved feedback signals is particularly advantageous in fast-changing channel conditions, since it can reduce the time between transmitting a pilot signal and updating a beamforming configuration.

### Example Environment

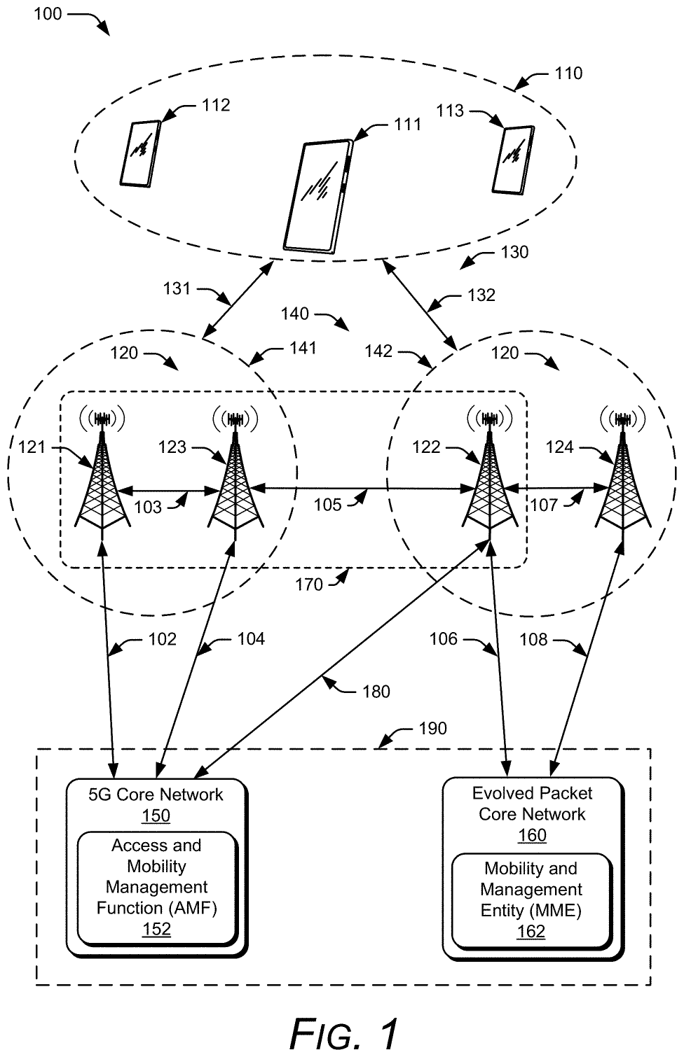

FIG. 1 illustrates an example environment 100 in which parallel beamforming training with coordinated base stations can be implemented. The environment 100 includes multiple user equipment 110 (UE 110), illustrated as UE 111, UE 112, and UE 113. Each UE 110 communicates with one or more base stations 120 (illustrated as base stations 121, 122, 123, and 124) through one or more wireless communication links 130 (wireless link 130), illustrated as wireless links 131 and 132. For simplicity, the UE 110 can be implemented as a smartphone but may be implemented as any suitable computing or electronic device, such as a mobile communication device, modem, cellular phone, gaming device, navigation device, media device, laptop computer, desktop computer, tablet computer, smart appliance, vehicle-based communication system, or an Internet-of-Things (IoT) device such as a sensor or an actuator. The base station 120 (e.g., an Evolved Universal Terrestrial Radio Access Network Node B, E-UTRAN Node B, evolved Node B, eNodeB, eNB, Next Generation Evolved Node B, ng-eNB, Next Generation Node B, gNode B, gNB, or the like) can be implemented in a macrocell, microcell, small cell, picocell, or the like, or any combination thereof.

The base stations 120 communicate with the UE 110 using the wireless links 131 and 132, which may be implemented as any suitable type of wireless link. The wireless links 131 and 132 include control and data communication, such as downlink of data and control information communicated from the base stations 120 to the UE 110, uplink of other data and control information communicated from the UE 110 to the base stations 120, or both. The wireless links 130 include one or more wireless links (e.g., radio links) or bearers implemented using any suitable communication protocol or standard, or combination of communication protocols or standards such as 3rd Generation Partnership Project Long-Term Evolution (3GPP LTE), Enhanced Long-Term Evolution (eLTE), Fifth-Generation New Radio (5G NR), Fourth-Generation (4G) standard, and so forth. Multiple wireless links 130 can be aggregated using carrier aggregation to provide a higher data rate for the UE 110. Multiple wireless links 130 from multiple base stations 120 can be configured for Coordinated Multipoint (CoMP) communication with the UE 110.

The base stations 120 are collectively a Radio Access Network 140 (e.g., RAN, Evolved Universal Terrestrial Radio Access Network, E-UTRAN, 5G NR RAN, or NR RAN) that each use a Radio Access Technology (RAT). The RANs 140 include an NR RAN 141 and an E-UTRAN 142. In FIG. 1, core networks 190 include a Fifth-Generation Core (5GC) network 150 (5GC 150) and an Evolved Packet Core (EPC) network 160 (EPC 160), which are different types of core networks. The base stations 121 and 123 in the NR RAN 141 connect to the 5GC 150. The base stations 122 and 124 in the E-UTRAN 142 connect to the EPC 160. Optionally or additionally, the base station 122 connects to both the 5GC 150 and EPC 160 networks.

The base stations 121 and 123 connect, at 102 and 104 respectively, to the 5GC 150 through an NG2 interface for control-plane signaling and using an NG3 interface for user-plane data communications. The base stations 122 and 124 connect, at 106 and 108 respectively, to the EPC 160 using an S1 interface for control-plane signaling and user-plane data communications. Optionally or additionally, if the base station 122 connects to the 5GC 150 and the EPC 160 networks, the base station 122 connects to the 5GC 150 using an NG2 interface for control-plane signaling and through an NG3 interface for user-plane data communications, at 180.

In addition to connections to core networks 190, the base stations 120 can communicate with each other. For example, the base stations 121 and 123 communicate through an Xn interface at 103, the base stations 122 and 123 communication through an Xn interface at 105, and the base stations 122 and 124 communicate through an X2 interface at 107.

The 5GC 150 includes an Access and Mobility Management Function 152 (AMF 152), which provides control-plane functions, such as registration and authentication of multiple UE 110, authorization, and mobility management in the 5G NR network. The EPC 160 includes a Mobility Management Entity 162 (MME 162), which provides control-plane functions, such as registration and authentication of multiple UE 110, authorization, or mobility management in the E-UTRAN network. The AMF 152 and the MME 162 communicate with the base stations 120 in the RANs 140 and also communicate with multiple UE 110 using the base stations 120.

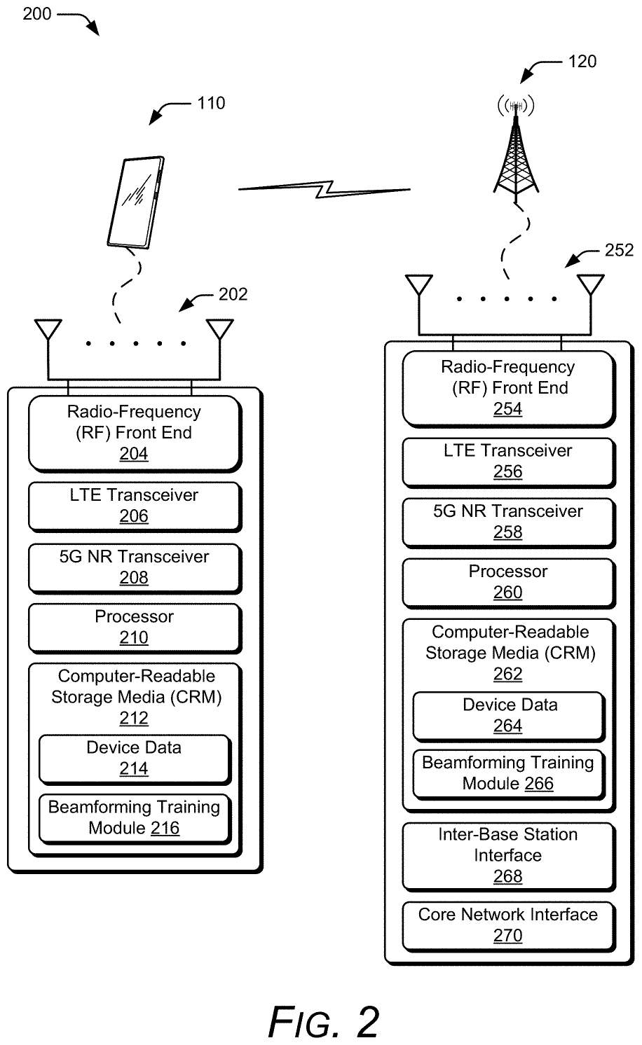

In the environment 100, the base stations 121, 122, and 123 form a coordination set 170. In general, the coordination set 170 includes two or more base stations 120 that coordinate scheduling for improving communications with the UE 110. In some cases, the coordination set 170 supports CoMP, Dual Connectivity (including multi-RAT or single-RAT DC), or MIMO. With multi-RAT dual-connectivity (MR-DC), the UE 110 connects to the 5GC 150 via the base stations 121 and 122, either of which can operate as the master node or the secondary node. With single-RAT DC, the UE 110 connects to the 5GC 150 via the base stations 121 and 123. Components of the UE 110 and the base station 120 are further described with respect to FIG. 2.

### Example Devices

FIG. 2 illustrates an example device diagram 200 of the UE 110 and the base station 120. The UE 110 and the base station 120 can include additional functions and interfaces that are omitted from FIG. 2 for the sake of clarity. The UE 110 includes antennas 202, a radio-frequency (RF) front end 204 (RF front end 204), an LTE transceiver 206, and a 5G NR transceiver 208 for communicating with one or more base stations 120 in the RAN 140. The RF front end 204 couples or connects the LTE transceiver 206 and the 5G NR transceiver 208 to the antennas 202 to facilitate various types of wireless communication. The antennas 202 can include an array of multiple antennas that are configured similar to or different from each other. The antennas 202 and the RF front end 204 can be tuned to one or more frequency bands defined by the 3GPP LTE and 5G NR communication standards and implemented by the LTE transceiver 206 and/or the 5G NR transceiver 208.

The UE 110 also includes one or more processors 210 and computer-readable storage media 212 (CRM 212). The processor 210 can be a single-core processor or a multi-core processor composed of a variety of materials, such as silicon, polysilicon, high-K dielectric, copper, and so on. The computer-readable storage media excludes propagating signals, and the CRM 212 includes any suitable memory or storage device, such as random-access memory (RAM), static RAM (SRAM), dynamic RAM (DRAM), non-volatile RAM (NVRAM), read-only memory (ROM), or Flash memory useable to store device data 214 of the UE 110. The device data 214 includes user data, multimedia data, beamforming codebooks, applications, and/or an operating system of the UE 110, which are executable by the processor 210 to enable user-plane communication, control-plane signaling, and user interaction with the UE 110.

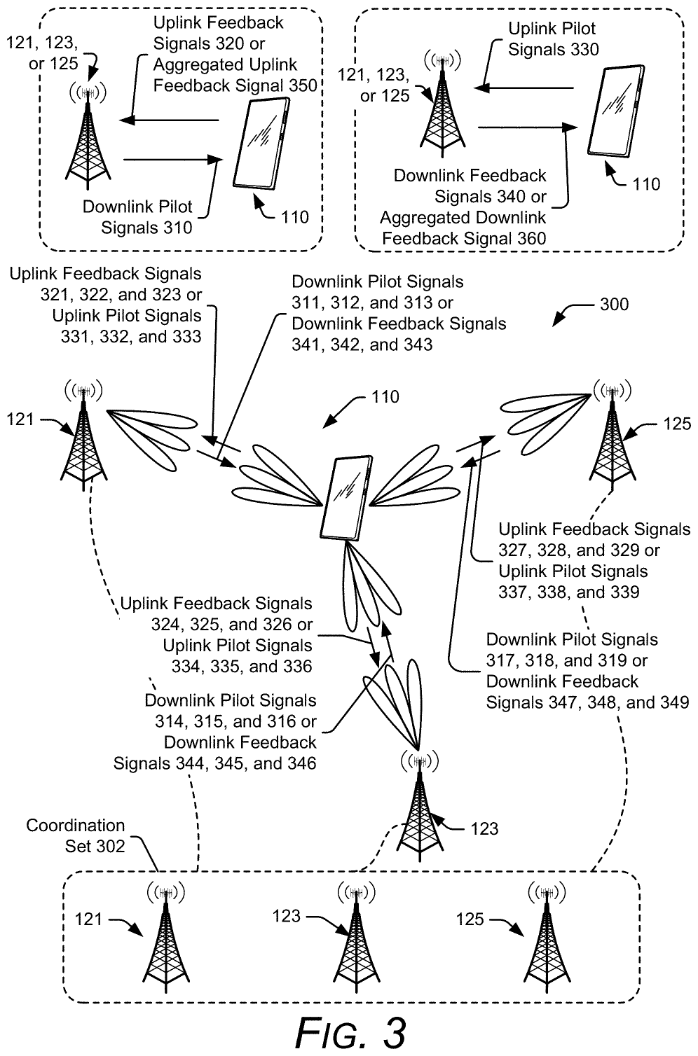

The CRM 212 also includes a beamforming training module 216. Alternatively or additionally, the beamforming training module 216 can be implemented in whole or part as hardware logic or circuitry integrated with or separate from other components of the UE 110. The beamforming training module 216 interleaves execution of beamforming training protocols with two or more base stations 120 within a coordination set 170 over time, as further described with respect to FIGS. 3 to 6.

The device diagram for the base station 120 includes a single network node (e.g., a gNB). The functionality of the base station 120 can be distributed across multiple network nodes or devices in any fashion suitable to perform the described functions. The base station 120 includes antennas 252, a radio-frequency (RF) front end 254, one or more LTE transceivers 256, and/or one or more 5G NR transceivers 258 for communicating with the UE 110. The RF front end 254 couples or connects the LTE transceiver 256 and the 5G NR transceiver 258 to the antennas 252 to facilitate various types of wireless communication. The antennas 252 can include an array of multiple antennas that are configured similar to or different from each other. The antennas 252 and the RF front end 254 can be tuned to one or more frequency bands defined by the 3GPP LTE and 5G NR communication standards, and implemented by the LTE transceiver 256, and/or the 5G NR transceiver 258. Additionally, the antennas 252, the RF front end 254, the LTE transceiver 256, and/or the 5G NR transceiver 258 can support beamforming, such as Massive-MIMO, for the transmission and reception of communications with the UE 110.

The base station 120 also includes one or more processors 260 and computer-readable storage media 262 (CRM 262). The processor 260 can be a single-core processor or a multi-core processor composed of a variety of materials, such as silicon, polysilicon, high-K dielectric, copper, and so on. The CRM 262 includes any suitable memory or storage device as described with respect to the CRM 212. The CRM 262 stores device data 264 of the base station 120. The device data 264 includes network scheduling data, radio resource management data, beamforming codebooks, applications, and/or an operating system of the base station 120, which are executable by the processor 260 to enable communication with the UE 110.

The CRM 262 also includes a beamforming training module 266. Alternatively or additionally, the beamforming training module 266 can be implemented in whole or part as hardware logic or circuitry integrated with or separate from other components of the base station 120. In at least some aspects, the beamforming training module 266 configures the LTE transceiver 256 and the 5G NR transceiver 258 for communication with the UE 110, as well as communication with the core network 190. The beamforming training module 266 enables execution of a beamforming training protocol with the UE 110 to be interleaved with one or more other beamforming training protocols performed by one or more other base stations within the coordination set 170, as further described with respect to FIGS. 3 to 6.

The base station 120 includes an inter-base station interface 268, such as an Xn and/or X2 interface, to exchange user-plane and control-plane data with another base station 120 and coordinate communications between the base stations 120 with the UE 110. The base station 120 also includes a core network interface 270 to exchange information with core network functions and entities.

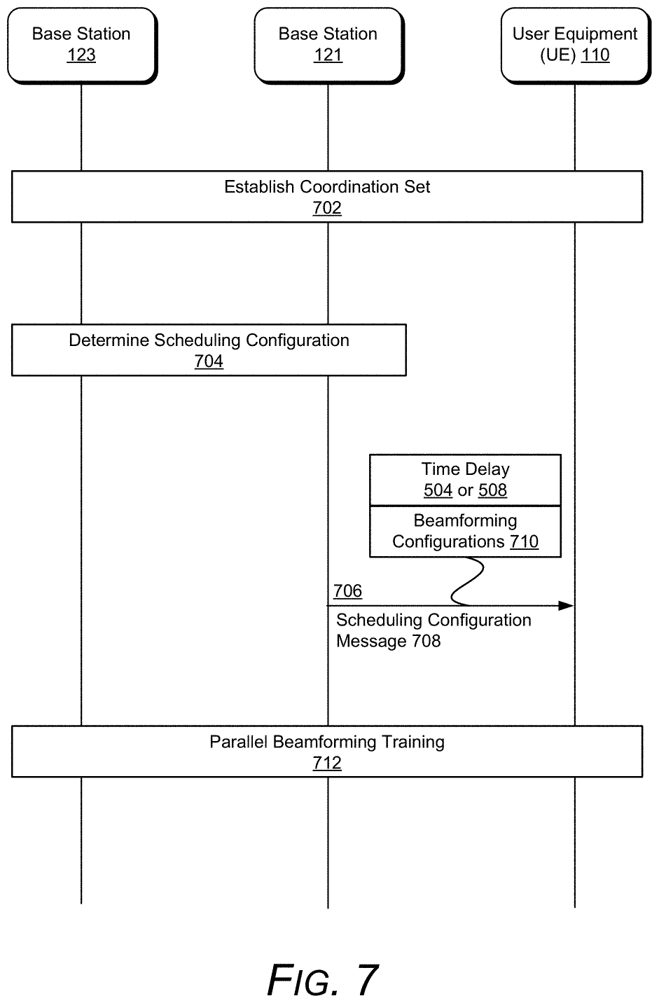

The beamforming training module 216 of the UE 110 and the beamforming training module 266 of the base station 120 can at least partially implement parallel beamforming training. FIG. 7 illustrates example signaling that can be performed using the beamforming training modules 216 and 266. FIG. 3 illustrates another example environment in which parallel beamforming training with coordinated base stations can occur.

Parallel Beamforming Training with Coordinated Base Stations

FIG. 3 illustrates example communication signals for parallel beamforming training with coordinated base stations. In an example environment 300, the UE 110 is physically located between base stations 121, 123, and 125 that are part of a coordination set 302. In some situations, the UE 110 can be located at cell edges associated with the base stations 121, 123, and 125. The base stations 121 and 123 represent gNBs, as shown in FIG. 1. The base station 125 can be another gNB or an eNB, such as the base station 122. In general, the coordination set 302 includes two or more base stations 120 that coordinate scheduling for improving communications with the UE 110. In some cases, the coordination set 302 supports CoMP, Dual Connectivity (including multi-RAT or single-RAT DC), or MIMO, as described above with respect to the coordination set 170 of FIG. 1.

The UE 110 executes beamforming training protocols with each base station 121, 123, and 125. The beamforming training protocol determines a pair of transmit and receive beamforming configurations that optimize (e.g., maximize, increase or result in a large amount of) channel gain. Increasing the channel gain facilitates mmW wireless communication by compensating for at least a portion of the path loss. The beamforming configurations can specify any one or more of: a direction of a main lobe, a beamwidth of the main lobe, a gain of the main lobe, a quantity of main lobes, or a precoding matrix indicator (PMI). The beamforming configurations can also specify beamforming parameters (e.g., weights and phase offsets) for conditioning signals associated with different antenna elements of an antenna array. The beamforming training protocol can include both downlink beamforming training and uplink beamforming training or include beamforming training in only one direction.

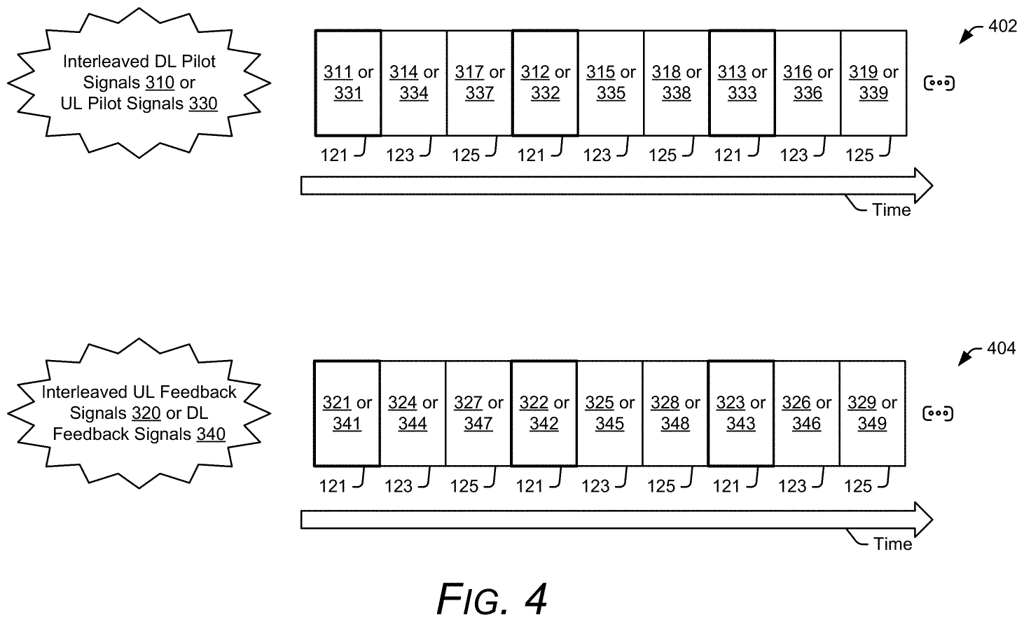

For downlink beamforming training, each base station 121, 123, and 125 transmits multiple downlink pilot signals 310. In the example environment 300, the base station 121 transmits downlink pilot signals 311, 312, and 313, the base station 123 transmits downlink pilot signals 314, 315, and 316, and the base station 125 transmits downlink pilots signals 317, 318, and 319. The downlink pilot signals 310 (e.g., 311, 312, 313, 314, 315, 316, 317, 318, 319) are reference signals and can have unique beamforming configurations. For the purposes of explanation, three downlink pilot signals are illustrated, while implementations may have any plurality of downlink pilot signals with various beamforming configurations. The beamforming configurations can scan main lobes of the downlink pilot signals 310 across a spatial region or cause beamwidths and directions of the main lobes to vary across the different downlink pilot signals 310. As further described with respect to FIG. 4, the base stations 121, 123, and 125 use TDM to interleave transmissions of the downlink pilot signals 310.

The UE 110 receives the downlink pilot signals 310 and demodulates the downlink pilot signals 310 to determine characteristics of a communication channel. For example, the UE 110 can measure signal strength of the downlink pilot signals 310 or measure amounts of interference present within the downlink pilot signals 310. The UE 110 can also analyze the downlink pilot signals 310 to determine channel state information (CSI), such as a channel quality indication (CQI), a precoding matrix indicator (PMI), and/or a rank indication (RI).

The UE 110 transmits one or more uplink feedback signals 320 to one or more base stations 121, 123, or 125 of the coordination set 302. The uplink feedback signals 320 include information that the UE 110 determined based on the received downlink pilot signals 310. For example, the uplink feedback signals 320 can include information indicative of any one or more of: the signal strength of the downlink pilot signals 310; the amount of interference present within the downlink pilot signals 310; and/or a channel state. In the environment 300, the UE 110 in one embodiment transmits multiple uplink feedback signals 320 to each base station 121, 123, and 125. The uplink feedback signals 320 respectively correspond to the downlink pilot signals 310. For example, the UE 110 transmits, to the base station 121, uplink feedback signals 321, 322, and 323 based on the downlink pilot signals 311, 312, and 313, respectively. For the base station 123, the UE 110 transmits uplink feedback signals 324, 325, and 326 based on the downlink pilot signals 314, 315, and 316, respectively. Similarly for the base station 125, the UE 110 transmits uplink feedback signals 327, 328, and 329 based on the downlink pilot signals 317, 318, and 319, respectively. As further described with respect to FIG. 4, the UE 110 uses TDM to interleave transmissions of the uplink feedback signals 320 to the base stations 121, 123, and 125.

To enable the base stations 121, 123, and 125 to associate an uplink feedback signal 320 with a corresponding downlink pilot signal 310, the downlink pilot signals 310 and uplink feedback signals 320 can include unique identifiers. For example, both the downlink pilot signal 311 and the uplink feedback signal 321 include a first unique identifier and both the downlink pilot signal 314 and the uplink feedback signal 324 include a second unique identifier. With the use of unique identifiers, the base stations 121, 123, and 125 can further determine whether or not a received uplink feedback signal 320 is associated with a different base station or if it did not receive a particular uplink feedback signal 320.

Instead of transmitting multiple uplink feedback signals 320 to the base stations 121, 123, and 125, the UE 110 can alternatively transmit at least one aggregated uplink feedback signal 350 to at least one of the base stations 121, 123, and 125 to reduce overhead and increase communication efficiency during the beamforming training protocol. In one implementation, the UE 110 transmits, to the base station 121, the aggregated uplink feedback signal 350, which includes feedback information based on the downlink pilot signals 310 associated with two or more base stations within the coordination set 302. Using the inter-base station interface 268 of FIG. 2, the base station that received the aggregated uplink feedback signal 350 communicates the feedback information to the other base stations in the coordination set 302. In another implementation, the UE 110 transmits different aggregated uplink feedback signals 350 to the base stations 121, 123, and 125. In this case, each aggregated uplink feedback signal 350 includes feedback information based on the downlink pilot signals 310 associated with the corresponding base station 121, 123, or 125.

In some cases, the UE 110 transmits the aggregated uplink feedback signal 350 using a different frequency band, such as a lower frequency band, relative to frequency bands of the downlink pilot signals 310. Additionally or alternatively, the UE 110 transmits the aggregated uplink feedback signal 350 with a wide beamwidth that encompasses angles to at least two of the base stations 121, 123, and 125. As an example, the UE 110 transmits the aggregated uplink feedback signal 350 using an omni-directional beamforming configuration. The wide beamwidth enables multiple base stations 121, 123, and 125 to receive the aggregated uplink feedback signal 350, which can reduce overhead across the inter-base station interface 268.

For uplink beamforming training, the UE 110 transmits uplink pilot signals 330 to the base stations 121, 123, and 125. For example, the UE 110 transmits uplink pilot signals 331, 332, and 333 to the base station 121, transmits uplink pilot signals 334, 335, and 336 to the base station 123, and transmits uplink pilot signals 337, 338, and 339 to the base station 125. The uplink pilot signals 330 are sounding reference signals and can have unique beamforming configurations. The beamforming configurations can scan main lobes of the uplink pilot signals 330 across a spatial region or cause beamwidths and directions of the main lobes to vary across the different uplink pilot signals 330. As further described with respect to FIG. 4, the UE 110 uses TDM to interleave transmissions of the uplink pilot signals 330 to the base stations 121, 123, and 125.

Prior to transmitting the uplink pilot signals 330, the UE 110 determines the beamforming configurations of the uplink pilot signals 330 based on one or more signals received from the base stations 121, 123, and 125. As an example, one of the base stations 121, 123, or 125 transmits a separate message, such as a scheduling configuration message shown in FIG. 7, to instruct the UE 110 to use a particular set of beamforming configurations for each of the base stations 121, 123, and 125. In other cases, the UE 110 can assume channel reciprocity to determine the beamforming configurations of the uplink pilot signals 330 that are associated with a particular base station 120 based on previously received downlink pilot signals 310 from that base station 120.

The base stations 121, 123, and 125 receive the uplink pilot signals 330 and demodulate the uplink pilot signals 330 to determine characteristics of communication channels with the UE 110. For example, the base stations 121, 123, and 125 can measure signal strength of the uplink pilot signals 330 or measure amounts of interference present within the uplink pilot signals 330. The base stations 121, 123, and 125 can also analyze the uplink pilot signals 330 to determine channel state information, such as channel quality indications, precoding matrix indicators, and/or rank indications.

The base stations 121, 123, and 125 transmit one or more downlink feedback signals 340 to the UE 110. The downlink feedback signals 340 include information that the base stations 121, 123, and 125 determined based on reception of the uplink pilot signals 330. For example, the downlink feedback signals 340 can include information indicative of any one or more of: the signal strength of the uplink pilot signals 330; the amount of interference present within the uplink pilot signals 340; and/or a channel state. In the environment 300, in one implementation each base station 121, 123, and 125 transmits multiple downlink feedback signals 340 (e.g., 341, 342, 343, 344, 345, 346, 347, 348, 349) to the UE 110. The downlink feedback signals 340 respectively correspond to the uplink pilot signals 330. For example, the base station 121 transmits, to the UE 110, downlink feedback signals 341, 342, and 343 based on the uplink pilot signals 331, 332, and 333 it received. The base station 123 transmits, to the UE 110, downlink feedback signals 344, 345, and 346 based on the uplink pilot signals 334, 335, and 336, respectively. Similarly, the base station 125 transmits, to the UE 110, downlink feedback signals 347, 348, and 349 based on the uplink pilot signals 337, 338, and 339, respectively.

In general, the base stations 121, 123, and 125 transmit downlink feedback signals 340 to the UE 110 based on the received uplink pilot signals 330. As such, a quantity of downlink feedback signals 340 equals a quantity of received uplink pilot signals 330. If the base stations 121, 123, or 125 did not receive one or more of the uplink pilot signals 330, the base stations 121, 123, or 125 will transmit, for example, fewer quantities of downlink feedback signals 340 to the UE 110 than the number of pilot signals 330 that the UE transmitted. As further described with respect to FIG. 4, the base stations 121, 123, and 125 use TDM to interleave transmissions of the downlink feedback signals 340.

To enable the UE 110 to associate a downlink feedback signal 340 with a corresponding uplink pilot signal 330, the uplink pilot signals 330 and the downlink feedback signals 340 can include unique identifiers. For example, both the uplink pilot signal 331 and the downlink feedback signal 341 include a first unique identifier- and both the uplink pilot signal 334 and the downlink feedback signal 344 include a second unique identifier. With the use of unique identifiers, the UE 110 can further determine if it did not receive a downlink feedback signal 340 corresponding to a particular uplink pilot signal 330 transmission.

Instead of transmitting individual downlink feedback signals 340 to the UE 110, one or more of the base stations 121, 123, or 125 can alternatively transmit an aggregated downlink feedback signal 360 to the UE 110 to reduce overhead and increase communication efficiency during the beamforming training protocol. In one implementation, the base station 121 transmits the aggregated downlink feedback signal 360, which includes feedback information based on the uplink pilot signals 330 associated with two or more base stations within the coordination set 302. Using the inter-base station interface 268 of FIG. 2, the base station that transmits the aggregated downlink feedback signal 360 can compile feedback information from the other base stations within the coordination set 302. In another implementation, the base stations 121, 123, and 125 transmit different aggregated downlink feedback signals 360 to the UE 110. In this case, each aggregated downlink feedback signal 360 includes feedback information based on the downlink pilot signals 310 received by the corresponding base station 121, 123, or 125.

Similar to the aggregated uplink feedback signal 350, the base station 121, 123, or 125 can transmit the aggregated downlink feedback signal 360 using a different frequency band, such as a lower frequency band, relative to frequency bands of the uplink pilot signals 330. Additionally or alternatively, the base station 121, 123, or 125 can transmit the aggregated downlink feedback signal 360 with a wide beamwidth. The wide beamwidth enables the aggregated downlink feedback signal 360 to be received at the UE 110 for situations in which a direction to the UE 110 is unknown for the transmission channel or the frequency band used to send the aggregated downlink feedback signal 360.

In some cases, the downlink pilot signals 310, the uplink feedback signals 320, the uplink pilot signals 330, and the downlink feedback signals 340 are millimeter-wave (mmW) signals. Although described with respect to 5GNR, the techniques for parallel beamforming training can also be applied to other generations of wireless communication. In general, the techniques for interleaving, over time, transmissions of the downlink pilot signals 310, the uplink feedback signals 320, the uplink pilot signals 330, the downlink feedback signals 340, or combinations thereof, across two or more base stations within the coordination set 302 create the opportunity for parallel beamforming training between the UE 110 and the different base stations of the coordination set 302, as further described with respect to FIGS. 4-6.

FIG. 4 illustrates example interleaving patterns of pilot signals and feedback signals for parallel beamforming training with coordinated base stations. In particular, an example interleaving pattern of the downlink pilot signals 310 or the uplink pilot signals 330 is shown at 402 and an example interleaving pattern of the uplink feedback signals 320 or the downlink feedback signals 340 is shown at 404. Each rectangle at 402 and 404 represents a time interval for communicating one type of beamforming training signal between the UE 110 and one of the base stations 121, 123, or 125. The time interval includes a transmission time and a reception time of the beamforming training signal. Although not explicitly shown, other types of signals can puncture the pattern or be included as part of the pattern without affecting the interleaved beamforming process.

At 402, transmission times of the downlink pilot signals 310 or the uplink pilot signals 330 are interleaved over time. In the depicted example, coordination amongst the base stations 121, 123, and 125 results in the base stations 121, 123, and 125 cycling between transmitting the downlink pilot signals 310. After the base station 121 transmits the downlink pilot signal 311, for example, the base station 123 transmits the downlink pilot signal 314, and the base station 125 transmits the downlink pilot signal 317. This transmission pattern can continue for the next set of downlink pilot signals 310, as shown by the transmission of the downlink pilot signal 312, 315, and 318. In this example, the base stations 121, 123, and 125 each transmit a downlink pilot signal 310 before transmitting a subsequent downlink pilot signal 310. In general, at least two base stations 120 within the coordination set 302 alternate transmissions of the downlink pilot signals 310. In other words, the base station 123 transmits at least one downlink pilot signal 310 in between times that the base station 121 transmits two other downlink pilot signals 310. The UE 110 receives the downlink pilot signals 310 in a pattern that the downlink pilot signals 310 are transmitted.

Similar to the downlink pilot signals 310, the UE 110 transmits the uplink pilot signals 330 in a pattern that cycles between the base stations 121, 123, and 125, as shown at 402. After the UE 110 transmits the uplink pilot signal 331 to the base station 121, for example, the UE 110 transmits the uplink pilot signal 334 to the base station 123 and transmits the uplink pilot signal 337 to the base station 125. This transmission pattern can continue for the next set of uplink pilot signals 330, as shown by the transmission of the uplink pilot signals 332, 335, and 338. In this example, the UE 110 transmits an uplink pilot signal 330 to each base station 121, 123, and 125 before transmitting a subsequent uplink pilot signal 330 to one of the base stations 121, 123, or 125. In general, the UE 110 alternates transmissions of uplink pilot signals 330 between at least two base stations 120 within the coordination set 302. In other words, the UE 110 transmits at least one uplink pilot signal 330 to the base station 123 in between times that the UE 110 transmits two other uplink pilot signals 330 to the base station 121. The base stations 121, 123, and 125 receive the uplink pilot signals 330 in a pattern that the uplink pilot signals 330 are transmitted by the UE 110.

At 404, transmissions of the uplink feedback signals 320 or the downlink feedback signals 340 are interleaved over time. In the depicted example, the UE 110 transmits the uplink feedback signals 320 in a pattern that cycles between the base stations 121, 123, and 125. After the UE 110 transmits the uplink feedback signal 321 to the base station 121, for example, the UE 110 transmits the uplink feedback signal 324 to the base station 123 and transmits the uplink feedback signal 327 to the base station 123. This transmission pattern can continue for the next set of uplink feedback signals 320, as shown by the transmission of uplink feedback signals 322, 325, and 328. In this example, the UE 110 transmits an uplink feedback signal 320 to each base station 121, 123, and 125 before transmitting a subsequent uplink feedback signal 320 to one of the base stations 121, 123, or 125. In general, the UE 110 alternates transmissions of uplink feedback signals 320 between at least two base stations 120 within the coordination set 302. In other words, the UE 110 transmits at least one uplink feedback signal 320 to the base station 123 in between times that the UE 110 transmits two other uplink feedback signals 320 to the base station 121. The base stations 121, 123, and 125 receive the uplink feedback signals 320 in a pattern that the uplink feedback signals 320 are transmitted by the UE 110.

Similar to the uplink feedback signals 320, the base stations 121, 123, and 125 cycle between transmitting the downlink feedback signals 340, as shown at 404. After the base station 121 transmits the downlink feedback signal 341, for example, the base station 123 transmits the downlink feedback signal 344, and the base station 125 transmits the downlink feedback signal 347. This transmission pattern can continue for the next set of downlink feedback signals 340, as shown by the transmission of the downlink feedback signals 342, 345, and 348. In this example, the base stations 121, 123, and 125 each transmit a downlink feedback signal 340 before transmitting a subsequent downlink feedback signal 340. In general, at least two base stations 120 within the coordination set 302 alternate transmissions of the downlink feedback signals 340. In other words, the base station 123 transmits at least one downlink feedback signal 340 in between times that the base station 121 transmits two other downlink feedback signals 340. The UE 110 receives the downlink feedback signals 340 in a pattern that the downlink feedback signals 340 are transmitted.

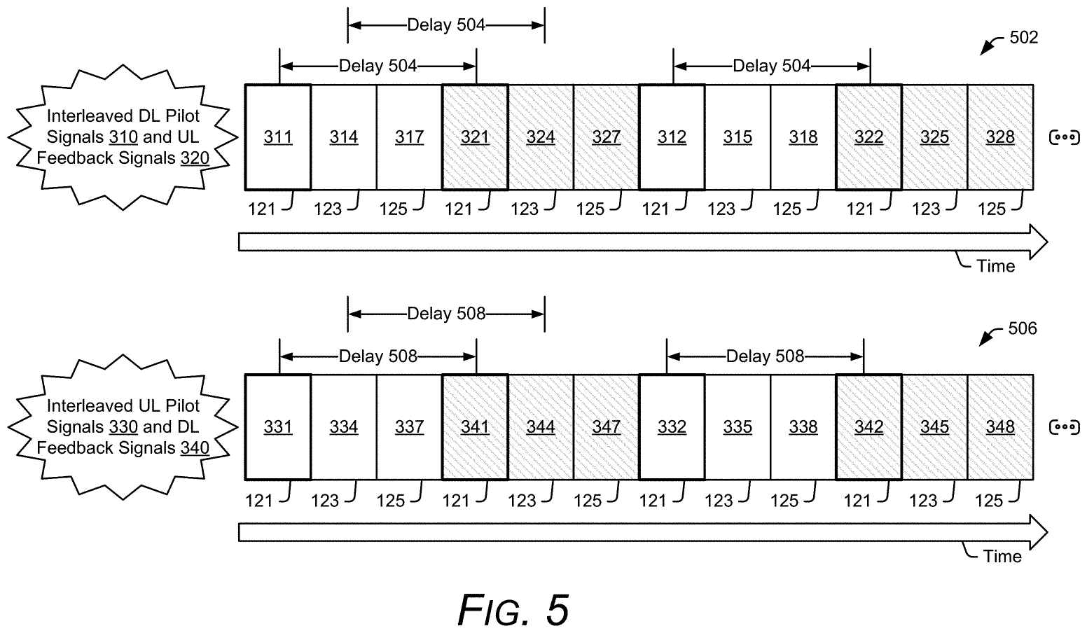

In some cases, one of the base stations 121, 123, and 125 transmits a scheduling configuration message to the UE 110, as shown in FIG. 7. The scheduling configuration message can specify beamforming configurations of the uplink pilot signals 330, the uplink feedback signals 320, or the aggregated uplink feedback signal 350. Additionally or alternatively, the scheduling configuration message can specify a timing relationship (e.g., a time delay) between the downlink pilot signals 310 and the corresponding uplink feedback signals 320, or a timing relationship between the uplink pilot signals 330 and the corresponding downlink feedback signals 340, as further described with respect to FIG. 5.

FIG. 5 illustrates other example interleaving patterns of pilot signals and feedback signals for parallel beamforming training with coordinated base stations. While FIG. 4 illustrates example interleaving patterns for each type of beamforming training signals, FIG. 5 illustrates example interleaving patterns between corresponding pilot signals and feedback signals. Sometimes this interleaving pattern is based on a specified timing relationship between the pilot signals and the feedback signals. The timing relationship enables the base stations 121, 123, and 125 or the UE 110 to receive the appropriate feedback signals by specifying time intervals in which to expect the feedback signals. It can also enable the base stations 121, 123, and 125 and the UE 110 to associate a previously transmitted pilot signal with its corresponding feedback signal.

At 502, one of the base stations 121, 123, or 125 transmits a scheduling coordination message to the UE 110. The scheduling coordination message specifies a time delay 504 between each downlink pilot signal 310 and each uplink feedback signal 320. In this example, the time delay 504 is similar for beamforming training signals associated with different base stations 121, 123, and 125. In other examples, the scheduling coordination message can specify multiple time delays that are unique to each base station 121, 123, and 125.

The UE 110 transmits the uplink feedback signals 321, 324, and 327 such that transmissions of the uplink feedback signals 321, 324, and 327 respectively occur after communications of the downlink pilot signals 311, 314, and 317 according to the time delay 504. Because the time delay 504 is constant for each of the base stations 121, 123, and 125, an interleaving pattern of the uplink feedback signals 320 corresponds to an interleaving pattern of the downlink pilot signals 310.

The base stations 121, 123, and 125 can associate an uplink feedback signal 320 with a corresponding downlink pilot signal 310 by matching a unique identifier of the uplink feedback signal 320 to a unique identifier of the downlink pilot signal 310. In this manner, the base stations 121, 123, and 125 can each determine whether or not a received uplink feedback signal 320 is associated with a different base station or if it did not receive a particular uplink feedback signal 320. The unique identifiers also enable the base stations 121, 123, and 125 to associate the uplink feedback signals 320 with the downlink pilot signals 310 without prior knowledge of the interleaving pattern of the uplink feedback signals 320 or without specifying the time delay 504.

Similarly at 506, the base stations 121, 123, and 125 specify a time delay 508 between each uplink pilot signal 330 and each downlink feedback signal 340. In this example, the time delay 508 is similar for beamforming training signals associated with different base stations 121, 123, and 125. As such, an interleaving pattern of the downlink feedback signals 340 corresponds to an interleaving pattern of the uplink pilot signals 330. In some cases, one of the base stations 121, 123, 125 transmits a scheduling configuration message to the UE 110 to inform the UE 110 of the time delay 508 associated with receiving the downlink feedback signals 340.

The UE 110 can associate a downlink feedback signal 340 with a corresponding uplink pilot signal 330 by matching a unique identifier of the downlink feedback signal 340 to a unique identifier of the uplink pilot signal 330. In this manner, the UE 110 can determine if it did not receive a particular downlink feedback signal 340. The unique identifiers also enable the UE 110 to associate the downlink feedback signals 340 with the uplink pilot signals 330 without prior knowledge of the interleaving pattern of the downlink feedback signals 340 or the time delay 508.

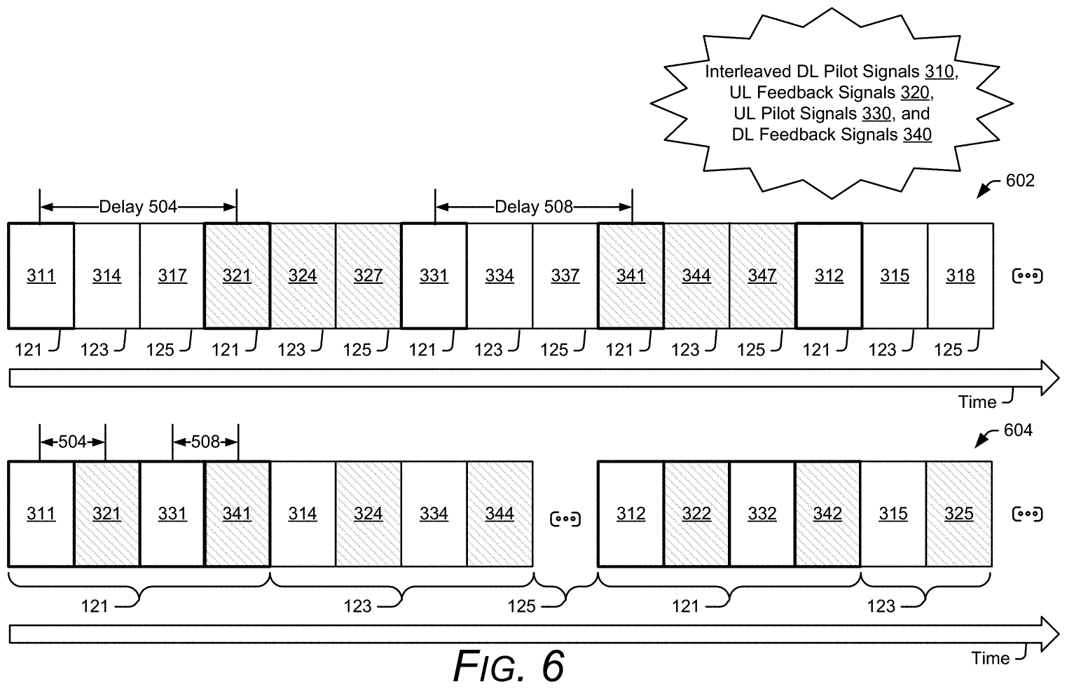

At 502 and 506, the time delays 504 and 508 are long enough to enable one downlink pilot signal 310 to be transmitted by each of the base stations 121, 123, and 125 or one uplink pilot signal 330 to be transmitted to each base station 121, 123, and 125. In other implementations, the time delay 504 is shorter and enables a portion of the base stations 121, 123, and 125 to transmit downlink pilot signals 310 before the UE 110 transmits the uplink feedback signals 320. Likewise, the time delay 508 can also be shorter and enable the UE 110 to transmit the uplink pilot signals 330 to a portion of the base stations 121, 123, and 125 before one of the base stations 121, 123, or 125 transmits the downlink feedback signal 340. In some cases, the time delays 504 and 508 jointly interleave the downlink pilot signals 310, the uplink feedback signals 320, the uplink pilot signals 330, and the downlink feedback signals 340 together over time, as further described with respect to FIG. 6.

FIG. 6 illustrates additional example interleaving patterns of pilot signals and feedback signals for parallel beamforming training with coordinated base stations. While FIG. 5 illustrates example interleaving patterns between corresponding pilot signals and feedback signals, FIG. 6 illustrates example interleaving patterns between pilot signals and feedback signals corresponding to both downlink beamforming training and uplink beamforming training. In this way, portions of downlink beamforming training and uplink beamforming training are performed in a TDM fashion across the base stations 121, 123, and 125.

At 602, the base stations 121, 123, and 125 respectively transmit the downlink pilot signals 311, 314, and 317, and the UE 110 respectively transmits the uplink feedback signals 321, 324, and 327 based on the time delay 504. Before the base stations 121, 123, and 125 transmit subsequent downlink pilot signals 310, the UE 110 transmits the uplink pilot signals 331, 334, and 337 and the base stations 121, 123, and 125 respectively transmit the downlink feedback signals 341, 344, and 347 based on the time delay 508. In this example, the beamforming training signals associated with a particular base station are interleaved with beamforming training signals associated with another base station.

At 604, groups of downlink pilot signals 310, uplink feedback signals 320, uplink pilot signals 330, and downlink feedback signals 340 are interleaved across the coordinated base stations 121, 123, and 125. A first set of beamforming training signals associated with the base station 121 occur followed by a second set of beamforming training signals associated with the base station 123. The first set of beamforming training signals includes the downlink pilot signal 311, the uplink feedback signal 321, the uplink pilot signal 331, and the downlink feedback signal 341. The second set of beamforming training signals includes the downlink pilot signal 314, the uplink feedback signal 324, the uplink pilot signal 334, and the downlink feedback signal 344. In this example, groups of beamforming training signals associated with a particular base station are interleaved with groups of beamforming training signals associated with another base station.

Although not explicitly shown, some parallel beamforming training can assume channel reciprocity to omit at least some of the uplink feedback signals 320 or at least some of the downlink feedback signals 340. For example, instead of transmitting the uplink feedback signals 320 to the base stations 121, 123, and 125 in response to receiving the downlink pilot signals 310, the UE 110 transmits the uplink pilot signals 330 to the base stations 121, 123, and 125. In this case, the UE 110 can determine beamforming configurations of the uplink pilot signals 330 based on angles of arrival of the downlink pilot signals 310. Using channel reciprocity, the base stations 121, 123, and 125 can select beam configurations for the uplink receive channel and the downlink transmit channel based on the uplink pilot signals 330. Likewise, the base stations 121, 123, and 125 can transmit downlink pilot signals 310 instead of downlink feedback signals 340 responsive to receiving the uplink pilot signals 330. Using channel reciprocity, the UE 110 can select beam configurations for the uplink transmit channel and the downlink receive channel based on the downlink pilot signals 310. This can reduce overhead and increase communication efficiency.

The interleaving pattern can also be adjusted based on expected rates at which channel conditions change. These expected rates can be based on movement at the UE 110 or the base stations 121, 123, or 125. UE 110 velocity can, for example, cause channel conditions to change between transmission times of a pilot signal and its corresponding feedback signal. Other conditions that dynamically affect channel conditions, especially for mmW signals, include precipitation and other weather phenomena, people or other obstructing masses traveling between the UE 110 and the base stations 121, 123, and 125. As such, the feedback signal can contain outdated feedback information. To provide appropriate feedback information for fast-changing channels, the interleaving pattern at 604 can be used to enable the feedback information to correspond with a time the feedback signal is transmitted. Alternatively, if movement at the UE 110 and the base stations 121, 123, and 124 are relatively slow, the interleaving pattern at 602 can be used. Although not explicitly shown, the coordination set 302 can vary the interleaving pattern over time based on detected variations in the channel conditions, a changing quantity of base stations 120 within the coordination set 302, variations of a measured velocity of the UE 110, or variations in a measured velocity of one or more of the base stations 121, 123, or 125 for situations in which the base stations 121, 123, and 125 include one or more moving base stations (e.g., a balloon, a drone, a high-altitude platform station, or a satellite).

FIG. 7 illustrates details of example signaling for parallel beamforming training with coordinated base stations. At 702, the core network 190 and/or the UE 110 establish the coordination set 302, which includes at least two base stations 121 and 123, for example. Coordination amongst the base stations 121 and 123 can be performed using an interface, such as the Xn interface. In some examples, the coordination set 302 supports CoMP, DC, or MIMO. Although not explicitly shown, the coordination set 302 can include additional base stations 120, such as the base station 125.

At 704, the base stations 121 and 123 of the coordination set 302 determine a scheduling configuration for interleaving beamforming training signals. The scheduling configuration represents interleaving patterns in which the beamforming training signals are transmitted and received. The beamforming training signals can include the downlink pilot signals 310, the uplink feedback signals 320, the uplink pilot signals 330, the downlink feedback signals 340, or combinations thereof. Example patterns are described above with respect to FIGS. 4 to 6.

At 706, one base station 121 of the coordination set 302 transmits a scheduling configuration message 708 to the UE 110. To facilitate the UE 110 receiving the scheduling configuration message 708, the base station 121 can transmit the scheduling configuration message 708 using a frequency band that is lower than a mmW frequency band (e.g., a sub-6 GHz frequency band), using a particular transmit power to increase a signal strength of the scheduling configuration message 708 at the UE 110, or using a lower modulation order to reduce a bit error rate, and so forth.

The scheduling configuration message 708 can specify the interleaving pattern, one or more time delays (e.g., the time delays 504 or 508), the beamforming configurations 710 of the beamforming training signals transmitted by the UE 110 (e.g., beamforming configurations of the uplink pilot signals 330 or the uplink feedback signals 320), or the unique identifiers of the beamforming training signals. The scheduling configuration message 708 can also specify whether feedback information is provided using multiple feedback signals or using an aggregated feedback signal, such as the aggregated uplink feedback signal 350 or the aggregated downlink feedback signal 360 of FIG. 3. Additionally, the scheduling configuration message 708 can specify whether or not the UE 110 is to assume channel reciprocity. In some implementations, the scheduling configuration message 708 is a layer-three (L3) message.

At 712, the UE 110 and the base stations 121 and 123 perform parallel beamforming training. The parallel execution of beamforming training protocols supports quick and effective communication between the UE 110 and each of the base stations 121 and 123 of the coordinate set 302. Interleaved transmissions of the downlink pilot signals 310, the uplink feedback signals 320, the uplink pilot signals 330, the downlink feedback signals 340, or combinations create the opportunity for parallel beamforming training between the UE 110 and the different base stations 121 and 123 of the coordination set 302, as shown in FIGS. 4 to 6.

### Example Methods

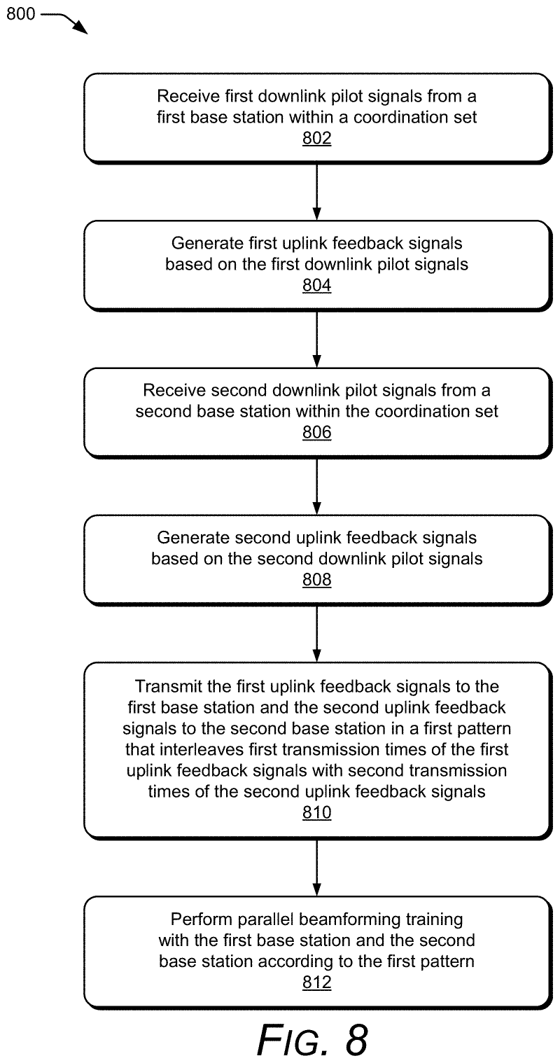

FIGS. 8, 9, 10, and 11 illustrate example methods for parallel beamforming training with coordinated base stations. Methods 800, 900, 1000, and 1100 are shown as a set of operations (or acts) performed but not necessarily limited to the order or combinations in which the operations are illustrated. Further, any of one or more of the operations may be repeated, combined, reorganized, skipped, or linked to provide a wide array of additional and/or alternate methods. In portions of the following discussion, reference may be made to environments 100 and 300 of FIGS. 1 and 3, and entities detailed in FIGS. 2 and 3, reference to which is made for example only. The techniques are not limited to performance by one entity or multiple entities operating on one device.

FIG. 8 illustrates an example method of a UE 110 for parallel beamforming training with coordinated base stations. In FIG. 8, the UE 110 uses TDM to interleave transmissions of uplink feedback signals that are associated with different coordinated base stations. By interleaving the uplink feedback signals, the UE 110 performs parallel beamforming training with the coordinated base stations.

At 802, the UE receives first downlink pilot signals from a first base station within a coordination set. For example, the UE 110 receives the downlink pilot signals 311, 312, and 313 from the base station 121 within the coordination set 302, as shown in FIG. 3.

At 804, the UE generates first uplink feedback signals based on the first downlink pilot signals. For example, the UE 110 generates the uplink feedback signals 321, 322, and 323 based on the downlink pilot signals 311, 312, and 313, respectively.

At 806, the UE receives second downlink pilot signals from a second base station within the coordination set. For example, the UE 110 receives the downlink pilot signals 314, 315, and 316 from the base station 123 within the coordination set 302, as shown in FIG. 3.

At 808, the UE generates second uplink feedback signals based on the second downlink pilot signals. For example, the UE 110 generates the uplink feedback signals 324, 325, and 326 based on the downlink pilot signals 314, 315, and 316, respectively. In some cases, the uplink feedback signals 321, 322, 323, 324, 325, and 326 include unique identifiers associated with the corresponding downlink pilot signals 311, 312, 313, 314, 315, and 316.

At 810, the UE transmits the first uplink feedback signals to the first base station and the second uplink feedback signals to the second base station in a first pattern that interleaves first transmission times of the first uplink feedback signals with second transmission times of the second uplink feedback signals. For example, the UE 110 transmits the uplink feedback signals 321, 322, and 323 to the base station 121 and the uplink feedback signals 324, 325, and 326 to the base station 123 in a first pattern that interleaves transmission times of the uplink feedback signals 321, 322, and 323 with transmission times of the uplink feedback signals 324, 325, and 326, as shown in FIG. 4 at 404, FIG. 5 at 502, and FIG. 6 at 602 and 604.

At 812, the UE performs parallel beamforming training with the first base station and the second base station according to the first pattern. For example, the UE 110 performs parallel beamforming training with the base station 121 and the base station 123 according to the first pattern.

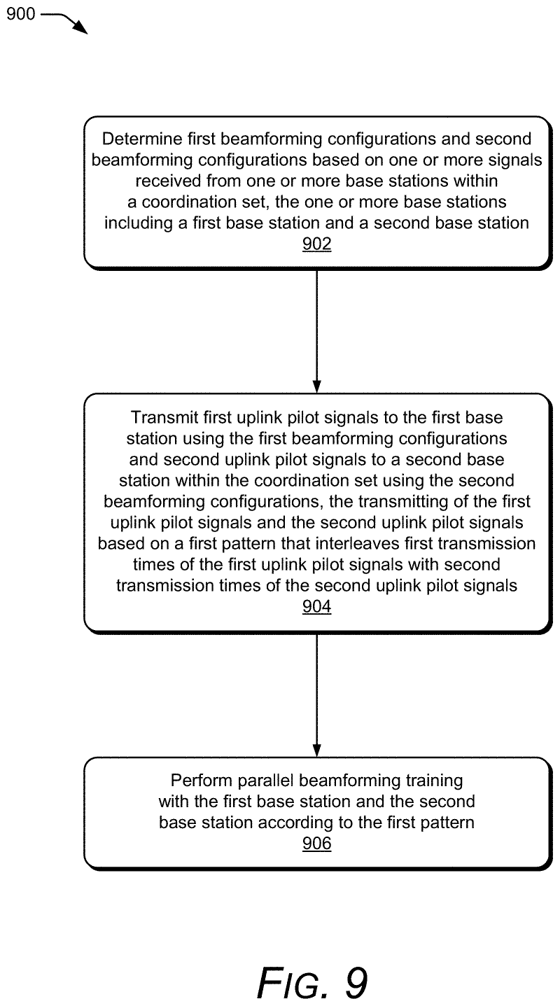

FIG. 9 illustrates another example method of a UE 110 for parallel beamforming training with coordinated base stations. In FIG. 9, the UE 110 uses TDM to interleave transmissions of uplink pilot signals that are associated with different coordinated base stations. By interleaving the uplink pilot signals, the UE 110 performs parallel beamforming training with the coordinated base stations.

At 902, the UE determines first beamforming configurations and second beamforming configurations based on one or more signals received from one or more base stations within a coordination set. The one or more base stations include a first base station and a second base station. For example, the UE 110 determines first beamforming configurations and second beamforming configurations based on one or more signals received from one or more base stations 121, 123, and 135 within a coordination set 302. In a first example, the UE 110 determines the beamforming configurations 710 based on the scheduling configuration message 708 of FIG. 7, which is transmitted by the base station 121. In a second example, the UE 110 uses channel reciprocity to determine the beamforming configurations based on downlink pilot signals 310 that are transmitted by the base stations 121, 123, and/or 125.

At 904, the UE transmits first uplink pilot signals to the first base station using the first beamforming configurations and second uplink pilot signals to the second base station using the second beamforming configurations. The transmitting of the first uplink pilot signals and the second uplink pilot signals based on a first pattern that interleaves first transmission times of the first uplink pilot signals with second transmission times of the second uplink pilot signals. For example, the UE 110 transmits the uplink pilot signals 331, 332, and 333 to the base station 121 using the first beamforming configurations and the uplink pilot signals 334, 335, and 336 to the base station 123 using the second beamforming configurations. The UE 110 transmits the uplink pilot signals 331, 332, 333, 334, 335, and 336 based on a first pattern that interleaves transmission times of the uplink pilot signals 331, 332, and 333 with transmission times of the uplink pilot signals 334, 335, and 336, as shown in FIG. 4 at 402, FIG. 5 at 506, and FIG. 6 at 602 and 604.

At 906, the UE performs parallel beamforming training with the first base station and the second base station according to the first pattern. For example, the UE 110 performs parallel beamforming training with the base stations 121 and 123 within the coordination set 302 according to the first pattern.

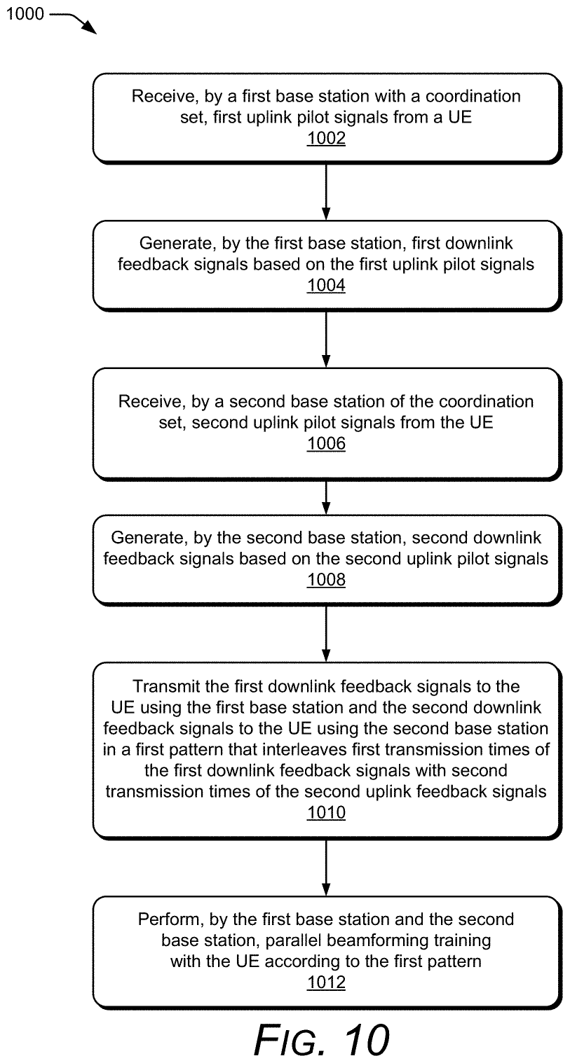

FIG. 10 illustrates an example method of a set of coordinated base stations for parallel beamforming training with a UE 110. In FIG. 10, the base stations 120 use TDM to interleave transmissions of downlink feedback signals across the coordinated base stations. By interleaving the downlink feedback signals, the coordinated base stations perform parallel beamforming training with the UE 110.

At 1002, a first base station within a coordination set receives first uplink pilot signals from a UE. For example, the base station 121 of the coordination set 302 receives uplink pilot signals 331, 332, and 333 from the UE 110, as shown in FIG. 3.

At 1004, the first base station generates first downlink feedback signals based on the first uplink pilot signals. For example, the base station 121 generates downlink feedback signals 341, 342, and 343 based on the uplink pilot signals 331, 332, and 333.

At 1006, a second base station within the coordination set receives second uplink pilot signals from the UE. For example, the base station 123 within the coordination set 302 receives the uplink pilot signals 334, 335, and 336 from the UE 110, as shown in FIG. 3.

At 1008, the second base station generates second downlink feedback signals based on the second uplink pilot signals. For example, the base station 123 generates the downlink feedback signals 344, 345, and 346 based on the uplink pilot signals 334, 335, and 336.

At 1010, the first base station transmits the first downlink feedback signals to the UE and the second base station transmits the second downlink feedback signals to the UE in a first pattern that interleaves first transmission times of the first downlink feedback signals with second transmission times of the second downlink feedback signals. For example, the base station 121 transmits the downlink feedback signals 341, 342, and 343 to the UE 110, and the base station 123 transmits the downlink feedback signals 344, 345, and 346 to the UE 110 based on one of the patterns shown in FIGS. 4 to 6.

At 1012, the first base station and the second base station perform parallel beamforming training with the UE according to the first pattern. For example, the base station 121 and the base station 123 perform parallel beamforming training with the UE 110 according to the first pattern.

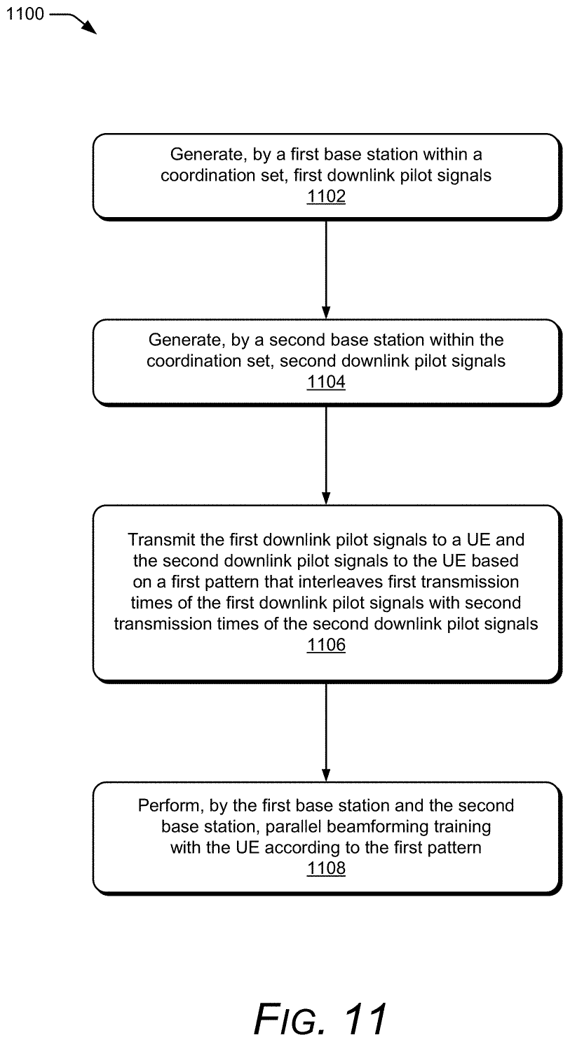

FIG. 11 illustrates another example method of a set of coordinated base stations for parallel beamforming training with a UE 110. In FIG. 11, the base stations 120 use TDM to interleave transmissions of downlink pilot signals across the coordinated base stations. By interleaving the downlink pilot signals, the coordinated base stations perform parallel beamforming training with the UE 110.

At 1102, a first base station within a coordination set generates first downlink pilot signals. For example, the base station 121 within the coordination set 302 generates downlink pilot signals 311, 312, and 313.

At 1104, a second base station within the coordination set generates second downlink pilot signals. For example, the base station 123 generates the downlink pilot signals 314, 315, and 316.

At 1106, the first base station transmits the first downlink pilot signals to the UE and the second base station transmits the second downlink pilot signals to the UE based on a first pattern that interleaves first transmission times of the first downlink pilot signals with second transmission times of the second downlink pilot signals. For example, the base station 121 transmits the downlink pilot signals 311, 312, and 313 to the UE 110, and the base station 123 transmits the downlink pilot signals 314, 315, and 316 to the UE 110 based on one of the patterns shown in FIGS. 4 to 6.

At 1108, the first base station and the second base station perform parallel beamforming training with the UE according to the first pattern. For example, the base station 121 and the base station 123 perform parallel beamforming training with the UE 110 according to the first pattern.

### CONCLUSION

Although techniques for parallel beamforming training using coordinated base stations have been described in language specific to features and/or methods, it is to be understood that the subject of the appended claims is not necessarily limited to the specific features or methods described. Rather, the specific features and methods are disclosed as example implementations of parallel beamforming training with coordinated base stations.

Some examples are described below.

Example 1: A Method for a user equipment, the method comprising the user equipment:

receiving first downlink pilot signals from a first base station within a coordination set;

generating first uplink feedback signals based on the first downlink pilot signals;

receiving second downlink pilot signals from a second base station within the coordination set;

generating second uplink feedback signals based on the second downlink pilot signals;

transmitting the first uplink feedback signals to the first base station and the second uplink feedback signals to the second base station in a first pattern that interleaves first transmission times of the first uplink feedback signals with second transmission times of the second uplink feedback signals; and

performing parallel beamforming training with the first base station and the second base station according to the first pattern.

Example 2: The method of example 1, wherein:

the first uplink feedback signals respectively correspond to the first downlink pilot signals;

the second uplink feedback signals respectively correspond to the second downlink pilot signals; and

first reception times of the first downlink pilot signals and second reception times of the second downlink pilot signals are interleaved together, wherein a second pattern represents the interleaving of the first downlink pilot signals with the second downlink pilot signals,

the method further comprising:
determining the first pattern based on the second pattern such that the first uplink feedback signals are interleaved with the second uplink feedback signal based on the interleaving of the first downlink pilot signals with the second downlink pilot signals.

Example 3: The method of example 2, further comprising:

receiving a scheduling configuration message from the first base station, the scheduling configuration message specifying a first time delay and a second time delay, wherein:

the first transmission times of the first uplink feedback signals are interleaved with the first reception times of the first downlink pilot signals based on the first time delay; and

the second transmission times of the second uplink feedback signals are interleaved with the second reception times of the second downlink pilot signals based on the second time delay.

Example 4: The method of example 3, wherein:

the first time delay is equal to the second time delay.

Example 5: The method of any preceding example, further comprising:

determining first beamforming configurations for the first uplink feedback signals; and

determining second beamforming configurations for the second uplink feedback signals, wherein:

the transmitting of the first uplink feedback signals uses the first beamforming configurations; and

the transmitting of the second uplink feedback signals uses the second beamforming configurations.

Example 6: The method of example 5, further comprising:

receiving a scheduling configuration message from the first base station, the scheduling configuration message including the first beamforming configurations and the second beamforming configurations.

Example 7: The method of any preceding example, wherein:

the receiving of the first downlink pilot signals includes determining first unique identifiers of the first downlink pilot signals based on the first downlink pilot signals;

the generating of the first uplink feedback signals includes incorporating the first unique identifiers;

the receiving the second downlink pilot signals includes determining second unique identifiers of the second downlink pilot signals based on the second downlink pilot signals; and

the generating the second uplink feedback signals includes incorporating the second unique identifiers.

Example 8: The method of any preceding example, further comprising:

generating first uplink pilot signals;

generating second uplink pilot signals; and

transmitting the first uplink pilot signals to the first base station and the second uplink pilot signals to the second base station based on a third pattern that interleaves third transmission times of the first uplink pilot signals with fourth transmission times of the second uplink pilot signals.

Example 9: The method of example 8, further comprising:

receiving an aggregated downlink feedback signal from the first base station, the aggregated downlink feedback signal including first feedback information from the first base station based on the first uplink pilot signals and second feedback information from the second base station based on the second uplink pilot signals.

Example 10: The method of example 8 or 9, further comprising:

determining the third pattern based on a fourth pattern that interleaves first reception times of the first downlink pilot signals with second reception times of the second downlink pilot signals.

Example 11: A method for a user equipment, the method comprising the user equipment:

determining first beamforming configurations and second beamforming configurations based on one or more signals received from one or more base stations within a coordination set, the one or more base stations including a first base station and a second base station;

transmitting first uplink pilot signals to the first base station using the first beamforming configurations and second uplink pilot signals to the second base station using the second beamforming configurations, the transmitting of the first uplink pilot signals and the second uplink pilot signals based on a first pattern that interleaves first transmission times of the first uplink pilot signals with second transmission times of the second uplink pilot signals; and

performing parallel beamforming training with the first base station and the second base station according to the first pattern.

Example 12: The method of example 11, wherein:

the determining of the first beamforming configurations and the second beamforming configurations comprises receiving a scheduling configuration message from the first base station, the scheduling configuration message including the first beamforming configurations and the second beamforming configurations.

Example 13: The method of example 12, wherein:

the scheduling configuration message specifies the first pattern.

Example 14: The method of example 11 or 12, further comprising:

receiving first downlink pilot signals from the first base station;

receiving second downlink pilot signals from the second base station, first reception times of the first downlink pilot signals are interleaved with second reception times of the second downlink pilot signals, a second pattern represents the interleaving of the first downlink pilot signals with the second downlink pilot signals; and

determining the first pattern based on the second pattern such that the first uplink pilot signals are interleaved with the second uplink pilot signals based on the interleaving of the first downlink pilot signals with the second downlink pilot signals.

Example 15: The method of example 14, wherein:

the determining of the first beamforming configurations uses first angle of arrival information of the first downlink pilot signals; and

the determining of the second beamforming configurations uses second angle of arrival information of the second downlink pilot signals.

Example 16: The method of example 14 or 15, further comprising:

generating first uplink feedback signals based on the first downlink pilot signals;

generating second uplink feedback signals based on the second downlink pilot signals; and

transmitting the first uplink feedback signals to the first base station and the second uplink feedback signals to the second base station in a third pattern that interleaves third transmission times of the first uplink feedback signals with fourth transmission times of the second uplink feedback signals.

Example 17: The method of any of examples 14-16, further comprising:

determining first feedback information based on the first downlink pilot signals;

determining second feedback information based on the second downlink pilot signals; and

transmitting an aggregated uplink feedback signal to the first base station, the aggregated uplink feedback signal including the first feedback information and the second feedback information.

Example 18: The method of any of examples 11-17, further comprising:

receiving first downlink feedback signals from the first base station, the first downlink feedback signals respectively corresponding to the first uplink pilot signals; and

receiving second downlink feedback signals from the second base station, the second downlink feedback signals respectively corresponding to the second uplink pilot signals,

wherein first reception times of the first downlink feedback signals are interleaved with second reception times of the second downlink feedback signals based on the interleaving of the first uplink pilot signals with the second uplink pilot signals.

Example 19: The method of example 18, further comprising:

generating the first uplink pilot signals to include first unique identifiers;

demodulating the first downlink feedback signals to extract first demodulated unique identifiers;

associating the first downlink feedback signals with corresponding first uplink pilot signals based on the first unique identifiers and the first demodulated unique identifiers;

generating the second uplink pilot signals to include second unique identifiers;

demodulating the second downlink feedback signals to extract the second demodulated unique identifiers; and

associating the second downlink feedback signals with corresponding second uplink pilot signals based on the second unique identifiers and the second demodulated unique identifiers.

Example 20: A user equipment comprising:

a radio-frequency transceiver; and

a processor and memory system configured to perform the method of any of examples 1-19.

Example 21: A computer-readable medium comprising instructions which, when executed by a processor, cause an apparatus incorporating the processor to perform the method of any of claims 1-19.

Example 22: A method for a first base station within a coordination set, the method comprising the first base station:

receiving, by the first base station, first uplink pilot signals from a user equipment;

generating, by the first base station, first downlink feedback signals based on the first uplink pilot signals;

coordinating with a second base station of the coordination set to transmit the first downlink feedback signals to the user equipment in a first pattern that interleaves first transmission times of the first downlink feedback signals with second transmission times of second downlink feedback signals that are transmitted by the second base station to the user equipment; and

performing, using the first pattern, parallel beamforming training with the user equipment according to the first pattern.

Example 23: The method of example 22, wherein:

the first downlink feedback signals respectively correspond to the first uplink pilot signals;

the second downlink feedback signals respectively correspond to second uplink pilot signals transmitted from the user equipment to the second base station; and

first reception times of the first uplink pilot signals and second reception times of the second uplink pilot signals are interleaved together, wherein a second pattern represents the interleaving of the first uplink pilot signals with the second uplink pilot signals,

the method further comprising:
determining the first pattern based on the second pattern such that the first downlink feedback signals are interleaved with the second downlink feedback signal based on the interleaving of the first uplink pilot signals with the second uplink pilot signals.

Example 24: The method of example 23, further comprising:

transmitting, by the first base station, a scheduling configuration message to the user equipment, the scheduling configuration message specifying a first time delay and a second time delay, wherein:

the first transmission times of the first downlink feedback signals are interleaved with the first reception times of the first uplink pilot signals based on the first time delay; and

the second transmission times of the second downlink feedback signals are interleaved with the second reception times of the second uplink pilot signals based on the second time delay.

Example 25: The method of example 24, wherein:

the first time delay is equal to the second time delay.

Example 26: The method of any of examples 22-25, further comprising:

transmitting, by the first base station, another scheduling configuration message to the user equipment, the other scheduling configuration message including first beamforming configurations for transmitting the first uplink pilot signals to the first base station and second beamforming configurations for transmitting the second uplink pilot signals to the second base station.

Example 27: The method of any of examples 22-26, wherein:

the receiving of the first uplink pilot signals includes determining first unique identifiers of the first uplink pilot signals based on the first uplink pilot signals; and

the generating of the first downlink feedback signals includes incorporating the first unique identifiers.

Example 28: The method of any of examples 22-27, further comprising:

generating, by the first base station, first downlink pilot signals; and

coordinating with the second base station to transmit the first downlink pilot signals to the user equipment in a third pattern that interleaves third transmission times of the first downlink pilot signals with fourth transmission times of second downlink pilot signals that are transmitted by the second base station to the user equipment.

Example 29: The method of example 28, further comprising:

receiving an aggregated uplink feedback signal from the user equipment, the aggregated uplink feedback signal including first feedback information based on the first downlink pilot signals and second feedback information based on the second downlink pilot signals.

Example 30: A base station comprising:

a radio-frequency transceiver; and

a processor and memory system configured to perform the method of any of examples 22-29.

Example 31: A computer-readable medium comprising instructions which, when executed by a processor, cause an apparatus incorporating the processor to perform the method of any of claims 22-28.

1. A method for a user equipment, the method comprising the user equipment:
receiving first downlink pilot signals from a first base station within a coordination set;
generating first uplink feedback signals based on the first downlink pilot signals;
receiving second downlink pilot signals from a second base station within the coordination set;
generating second uplink feedback signals based on the second downlink pilot signals;
transmitting the first uplink feedback signals to the first base station and the second uplink feedback signals to the second base station in a first pattern that interleaves first transmission times of the first uplink feedback signals with second transmission times of the second uplink feedback signals; and
performing parallel beamforming training with the first base station and the second base station according to the first pattern.

2. The method of claim 1, wherein:
the first uplink feedback signals respectively correspond to the first downlink pilot signals;
the second uplink feedback signals respectively correspond to the second downlink pilot signals; and
first reception times of the first downlink pilot signals and second reception times of the second downlink pilot signals are interleaved together, wherein a second pattern represents the interleaving of the first downlink pilot signals with the second downlink pilot signals,
the method further comprising:
determining the first pattern based on the second pattern such that the first uplink feedback signals are interleaved with the second uplink feedback signal based on the interleaving of the first downlink pilot signals with the second downlink pilot signals.

3. The method of claim 2, further comprising:
receiving a scheduling configuration message from the first base station, the scheduling configuration message specifying a first time delay and a second time delay, wherein:
the first transmission times of the first uplink feedback signals are interleaved with the first reception times of the first downlink pilot signals based on the first time delay; and
the second transmission times of the second uplink feedback signals are interleaved with the second reception times of the second downlink pilot signals based on the second time delay.

4. (canceled)

5. The method of claim 1, further comprising:
determining first beamforming configurations for the first uplink feedback signals; and
determining second beamforming configurations for the second uplink feedback signals, wherein:
the transmitting of the first uplink feedback signals uses the first beamforming configurations; and
the transmitting of the second uplink feedback signals uses the second beamforming configurations.

6. The method of claim 5, further comprising:
receiving a scheduling configuration message from the first base station, the scheduling configuration message including the first beamforming configurations and the second beamforming configurations.

7. The method of claim 1, wherein:
the receiving of the first downlink pilot signals includes determining first unique identifiers of the first downlink pilot signals based on the first downlink pilot signals;
the generating of the first uplink feedback signals includes incorporating the first unique identifiers;
the receiving the second downlink pilot signals includes determining second unique identifiers of the second downlink pilot signals based on the second downlink pilot signals; and
the generating the second uplink feedback signals includes incorporating the second unique identifiers.

8. The method of claim 1, further comprising:
generating first uplink pilot signals;
generating second uplink pilot signals; and
transmitting the first uplink pilot signals to the first base station and the second uplink pilot signals to the second base station based on a third pattern that interleaves third transmission times of the first uplink pilot signals with fourth transmission times of the second uplink pilot signals.

9. The method of claim 8, further comprising:
receiving an aggregated downlink feedback signal from the first base station, the aggregated downlink feedback signal including first feedback information from the first base station based on the first uplink pilot signals and second feedback information from the second base station based on the second uplink pilot signals.

10. The method of claim 8, further comprising:
determining the third pattern based on a fourth pattern that interleaves first reception times of the first downlink pilot signals with second reception times of the second downlink pilot signals.

11. A method for a user equipment, the method comprising the user equipment:
determining first beamforming configurations and second beamforming configurations based on one or more signals received from one or more base stations within a coordination set, the one or more base stations including a first base station and a second base station;
transmitting first uplink pilot signals to the first base station using the first beamforming configurations and second uplink pilot signals to the second base station using the second beamforming configurations, the transmitting of the first uplink pilot signals and the second uplink pilot signals based on a first pattern that interleaves first transmission times of the first uplink pilot signals with second transmission times of the second uplink pilot signals; and
performing parallel beamforming training with the first base station and the second base station according to the first pattern.

12. The method of claim 11, wherein:
the determining of the first beamforming configurations and the second beamforming configurations comprises receiving a scheduling configuration message from the first base station, the scheduling configuration message including the first beamforming configurations and the second beamforming configurations.

13. The method of claim 12, wherein:
the scheduling configuration message specifies the first pattern.

14. The method of claim 11, further comprising:
receiving first downlink pilot signals from the first base station;
receiving second downlink pilot signals from the second base station, first reception times of the first downlink pilot signals are interleaved with second reception times of the second downlink pilot signals, a second pattern represents the interleaving of the first downlink pilot signals with the second downlink pilot signals; and
determining the first pattern based on the second pattern such that the first uplink pilot signals are interleaved with the second uplink pilot signals based on the interleaving of the first downlink pilot signals with the second downlink pilot signals.

15. The method of claim 14, wherein:
the determining of the first beamforming configurations uses first angle of arrival information of the first downlink pilot signals; and
the determining of the second beamforming configurations uses second angle of arrival information of the second downlink pilot signals.

16. The method of claim 14, further comprising:
generating first uplink feedback signals based on the first downlink pilot signals;
generating second uplink feedback signals based on the second downlink pilot signals; and
transmitting the first uplink feedback signals to the first base station and the second uplink feedback signals to the second base station in a third pattern that interleaves third transmission times of the first uplink feedback signals with fourth transmission times of the second uplink feedback signals.

17. The method of claim 14, further comprising:
determining first feedback information based on the first downlink pilot signals;
determining second feedback information based on the second downlink pilot signals; and
transmitting an aggregated uplink feedback signal to the first base station, the aggregated uplink feedback signal including the first feedback information and the second feedback information.

18. The method of claim 11, further comprising:
receiving first downlink feedback signals from the first base station, the first downlink feedback signals respectively corresponding to the first uplink pilot signals; and
receiving second downlink feedback signals from the second base station, the second downlink feedback signals respectively corresponding to the second uplink pilot signals,
wherein first reception times of the first downlink feedback signals are interleaved with second reception times of the second downlink feedback signals based on the interleaving of the first uplink pilot signals with the second uplink pilot signals.

19. The method of claim 18, further comprising:
generating the first uplink pilot signals to include first unique identifiers;
demodulating the first downlink feedback signals to extract first demodulated unique identifiers;
associating the first downlink feedback signals with corresponding first uplink pilot signals based on the first unique identifiers and the first demodulated unique identifiers;
generating the second uplink pilot signals to include second unique identifiers;
demodulating the second downlink feedback signals to extract the second demodulated unique identifiers; and
associating the second downlink feedback signals with corresponding second uplink pilot signals based on the second unique identifiers and the second demodulated unique identifiers.

20. A user equipment configured to:
receive first downlink pilot signals from a first base station within a coordination set;
generate first uplink feedback signals based on the first downlink pilot signals;
receive second downlink pilot signals from a second base station within the coordination set;
generate second uplink feedback signals based on the second downlink pilot signals;
transmit the first uplink feedback signals to the first base station and the second uplink feedback signals to the second base station in a first pattern that interleaves first transmission times of the first uplink feedback signals with second transmission times of the second uplink feedback signals; and
perform parallel beamforming training with the first base station and the second base station according to the first pattern.

21. A computer-readable medium comprising instructions which, when executed by a processor, cause an apparatus incorporating the processor to:
receive first downlink pilot signals from a first base station within a coordination set;
generate first uplink feedback signals based on the first downlink pilot signals;
receive second downlink pilot signals from a second base station within the coordination set;
generate second uplink feedback signals based on the second downlink pilot signals;
transmit the first uplink feedback signals to the first base station and the second uplink feedback signals to the second base station in a first pattern that interleaves first transmission times of the first uplink feedback signals with second transmission times of the second uplink feedback signals; and
perform parallel beamforming training with the first base station and the second base station according to the first pattern.
